(19) United States
(12) Patent Application Publication
(10) Pub. No.: US 2014/0027965 A1
(43) Pub. Date: Jan. 30, 2014

(54) CONSTANT-FORCE SPRING SYSTEMS

(71) Applicants: Michael Holloway, Cherry Hill, NJ (US); Michael Colvin Andrews, Erdenheim, PA (US); Jonathan Michael Royer, Warminster, PA (US)

(72) Inventors: Michael Holloway, Cherry Hill, NJ (US); Michael Colvin Andrews, Erdenheim, PA (US); Jonathan Michael Royer, Warminster, PA (US)

(73) Assignee: Ametek, Horsham, PA (US)

(21) Appl. No.: 13/560,231

(22) Filed: Jul. 27, 2012

(51) Int. Cl. F16F 3/04

(52) U.S. Cl. 267/156

(57) ABSTRACT

Adjustable constant force spring systems are disclosed. An adjustable constant-force spring system includes first and second rolled metal strips and a spool. The first strip is rolled around a first axis. The first strip has an inner end adjacent the first axis and an outer end configured for selective attachment to a load. The second strip is rolled around the first axis such that the second strip overlaps the first strip. The second strip has an inner end adjacent the first axis and an outer end configured for selective attachment to the load. The spool is located on a second axis parallel to and spaced from the first axis. The spool is sized to enable the first strip to reroll around the spool.

### FIELD OF THE INVENTION

This invention relates generally to springs, and more particularly, to constant-force springs.

### BACKGROUND OF THE INVENTION

A constant-force spring is a spring that exerts a predetermined force (generally predetermined to be constant over its entire range of motion/extension). A mechanical constant-force spring is conventionally formed from a strip of metal that has been formed into a spiral. The strip of metal is relaxed when it is in the fully rolled position, and supplies a spring force when a load causes the strip of metal to unroll.

A constant-force spring applies substantially the same force on a load regardless of the size of the load, or the degree of extension (or unrolling) of the spring. Accordingly, conventional constant-force springs may not be suitable for applications that experience dynamic loads.

### SUMMARY OF THE INVENTION

Aspects of the present invention are related to adjustable constant force spring systems.

In accordance with one aspect of the present invention, an adjustable constant-force spring system is disclosed. The system includes first and second rolled metal strips and a spool. The first strip is rolled around a first axis. The first strip has an inner end adjacent the first axis and an outer end configured for selective attachment to a load. The second strip is rolled around the first axis such that the second strip overlaps the first strip. The second strip has an inner end adjacent the first axis and an outer end configured for selective attachment to the load. The spool is located on a second axis parallel to and spaced from the first axis. The spool is sized to enable the first strip to reroll around the spool.

In accordance with another aspect of the present invention, another adjustable constant-force spring system is disclosed. The system includes a circular drum positioned around a first axis, a plurality of rolled metal strips positioned around the drum, and a spool fixedly coupled to the drum. The plurality of strips are rolled around the drum in overlapping fashion, each strip having an inner end adjacent the drum and an outer end configured for selective attachment to the load. The spool is located on a second axis parallel to and spaced from the first axis. An outermost strip of the plurality of strips is configured to unroll when its outer end is attached to the load. An inner strip of the plurality of strips is configured to unroll when the outermost strip unrolls. The inner strip is configured to reroll around the spool when the inner strip is unrolled and is unattached to the load.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. According to common practice, the various features of the drawings are not drawn to scale unless otherwise indicated. To the contrary, the dimensions of the various features may be expanded or reduced for clarity. Included in the drawings are the following figures:

FIGS. 1A-1C are images illustrating an exemplary adjustable constant-force spring system in accordance with aspects of the present invention; and

FIG. 2 is a diagram illustrating overlapping metal strips of the exemplary system of FIGS. 1A-1C.

### DETAILED DESCRIPTION OF THE INVENTION

Aspects of the present invention are directed to a constant-force spring system that enables adjustment of the constant force to be applied to a load. The disclosed systems include a number of constant-force spring elements that may be selectively coupled to the load. The constant-force may thereby be adjusted based on the force associated with each spring element and the number of constant-force spring elements coupled to the load.

It will be understood by one of ordinary skill in the art that spring elements commonly referred to as “constant-force” springs may provide different levels of force over the range of their extension. For example, most constant-force springs may exert a substantially constant force over their entire range of extension. However, some other constant-force springs may exert a stepped pattern of constant forces, e.g., a first constant force for a first range of extension, and a second constant force for a second range of extension. Still other constant-force springs may exert a sloped pattern of forces, e.g., a force that continuously varies over the range of extension of the spring. The type of constant-force spring, and the force it applies, may be selected based on the materials and internal diameter of the appropriate portions of the constant-force spring, as would be understood by one of ordinary skill in the art. Accordingly, as used herein, the term “constant-force spring” is intended to encompass all varieties of constant-force springs (including those described above), and not merely those spring elements that provide a substantially or approximately constant force over the entire course of their extension.

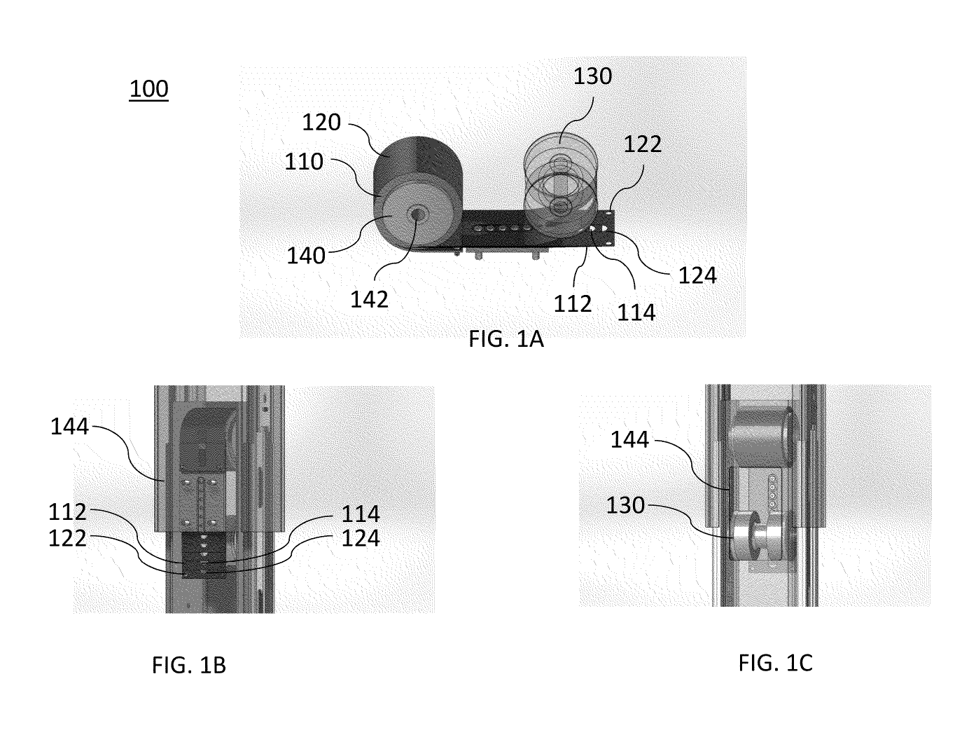

FIGS. 1A-1C illustrate an exemplary constant-force spring system in accordance with aspects of the present invention. System 100 allows a user to adjust the level of constant-force applied by the system to the load. As a general overview, system 100 includes a first rolled metal strip 110, a second rolled metal strip 120, and a spool 130. Additional details of system 100 are described below.

First rolled metal strip 110 is a constant force spring element. Strip 110 is a strip of metal formed into a substantially spiral shape around an axis. Strip 110 is manufactured such that strip 110 is relaxed when in the fully rolled position. When strip 110 is unrolled (e.g., during attachment to a load), strip 110 applies a spring force to restore strip 110 to the rolled position. When strip 110 is unrolled, it provides a constant force that is substantially independent of the unrolled length of strip 110.

Strip 110 has an inner end (not shown) adjacent the central axis and an outer end 112 distal from the central axis. It may be desirable that the inner and outer ends of strip 110 are approximately the same distance from the axis in the fully rolled position, such that strip 110 has an approximately constant radius. This may be achieved by using a thin strip of material for strip 110.

Outer end 112 of strip 110 is configured for selective attachment to a load. In an exemplary embodiment, outer end 112 includes an attachment point, as shown in FIGS. 1A-1C. The attachment point may be, for example, a hole 114 formed in strip 110. The hole is configured to receive a projection or other mating structure coupled to the load.

Second rolled metal strip 120 is another constant force spring element. Strip 120 may be substantially the same as first rolled metal strip 110. Like strip 110, strip 120 has an inner end (not shown) adjacent the central axis and an outer end 122 distal from the central axis. Outer end 122 of strip 120 is configured for selective attachment to a load. In an exemplary embodiment, outer end 122 includes an attachment point such as, for example, a hole 124 formed in strip 120, as shown in FIGS. 1A-1C. Strip 120 may be formed from the same materials and process as strip 110, and may have substantially the same dimensions as strip 110.

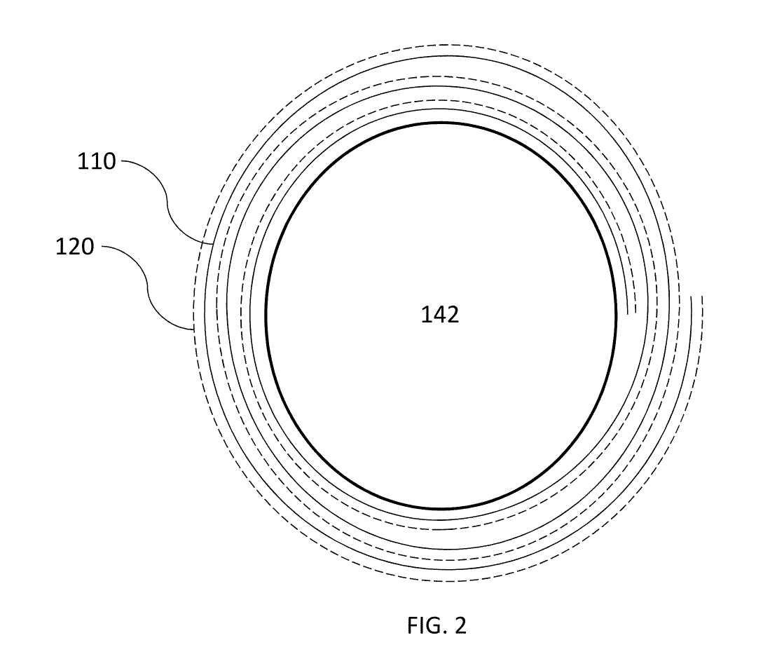

Strip 120 is rolled in overlapping fashion with strip 110. A diagram illustrating overlapping rolled strips 110 and 120 is shown in FIG. 2 in accordance with aspects of the present invention. For the purposes of illustration in FIG. 2, strip 110 is shown in with a solid line, and strip 120 is shown with a dashed line. It will be understood that the number of revolutions and space between each revolution shown in FIG. 2 are merely for the purposes of illustration, and are not intended to be limiting. Suitable processes for rolling strips 110 and 120 in overlapping fashion will be known to one of ordinary skill in the art from the description herein.

As set forth above, when strips 110 and 120 are unrolled, they each provide a constant force that is substantially independent of their respective unrolled lengths. The constant force supplied by strips 110 and 120 is dependent at least in part on their respective materials, widths, thicknesses, and radii. Accordingly, by varying the dimensions of strips 110 and 120, the constant forces provided when strips 110 and 120 are unrolled may be preselected. In an exemplary embodiment, strips 110 and 120 may provide the same constant forces (e.g., 5 lbs. of force). In an alternative exemplary embodiment, strips 110 and 120 may provide different constant forces.

Spool 130 is located on a second axis different from the first axis around which strips 110 and 120 are rolled. The second axis is spaced from the first axis by a fixed distance. As will be discussed in greater detail below, spool 130 is configured to receive the outer portion of strip 110, when strip 110 is not connected to a load. Thus, spool 130 is sized to enable strip 110 to reroll (i.e. reform into its relaxed, rolled shape) around spool 130. In an exemplary embodiment, spool 130 is a round drum having an outer diameter at least as long as an inner diameter of strip 110 in its fully rolled position. Preferably, spool 130 has an outer diameter greater than the inner diameter of strip 110 in its fully rolled position, in order to facilitate relaxation of strip 110 into its original fully rolled position when strip 120 is disconnected from the load. It will be understood by one of ordinary skill in the art that spool 130 may have substantially any shape that allows strip 110 to reroll around spool 130.

It will be understood that system 100 is not limited to the above features, but may include additional and/or alternative features, as set forth below.

System 100 may further include a housing 140. In an exemplary embodiment, first and second strips 110 and 120 are positioned within housing 140. As shown in FIGS. 1A-1C, housing 140 may comprise sidewalls extending along the sides of first and second strips 110 and 120. Housing 140 may further comprise a circular drum portion 142, around which first and second strips 110 and 120 are rolled. In this embodiment, the inner ends of strips 110 and 120 are positioned adjacent drum portion 142, and the outer ends 112 and 122 protrude from housing 140 toward spool 130. While not shown in FIGS. 1A-1C, housing 140 may further comprise a circumferential outer wall extending around substantially all of the outer part of strips 110 and 120, with an aperture to allow outer ends 112 and 122 to protrude therefrom.

Housing 140 is fixedly coupled to spool 130. Accordingly, spool 130 may be maintained at a fixed distance from strips 110 and 120. In an exemplary embodiment, housing 140 includes an extended portion 144 extending from housing 140 toward spool 130. Spool 130 is fixed to housing 140 via extended portion 144. As shown in FIGS. 1A-1C, in an exemplary embodiment, outer ends 112 and 122 extend from the rolled portions of strips 110 and 120 in a direction substantially parallel to the direction of extended portion 144. Outer ends 112 and 122 are sufficiently biased to reroll around spool 130 when unconnected to the load, as explained in greater detail below.

While system 100 is described above as including two rolled metal strips, it will be understood by one of ordinary skill in the art that the invention is not so limited. To the contrary, as shown in FIGS. 1A-1C, system 100 may include a plurality of metal strips greater than two, each rolled around each other in overlapping fashion. By including a greater number of rolled metal strips, system 100 may achieve greater adjustability in the constant force applied to the load, as will be explained in greater detail below.

An operation of system 100 will now be described in accordance with aspects of the present invention. Strips 110 and 120 are each configured for selective attachment to a load (e.g., via attachment points 114 and 124). Strips 110 and 120 are configured to unroll when their respective outer ends 112 and 122 are attached to the load, i.e., when a force is provided on the outer ends of strips 110 and 120 in a direction away from the rolled portions of strips 110 and 120. When strips 110 and 120 are unrolled (e.g., during attachment to the load), the strips apply a constant spring force to restore themselves to the rolled position.

The constant force applied by strips 110 and 120 may be preselected based on the materials and dimensions of strips 110 and 120, as described above. Accordingly, in accordance with aspects of the present invention, the constant force provided by system 100 may be adjusted based on the number of strips attached to the load. For example, strips 110 and 120 may each be preselected to provide a constant force of approximately 5 lbs. In this example, a user of system 100 may choose to apply a constant force of 5 lbs. to the load (by attaching the load only to strip 120) or a constant force of 10 lbs. to the load (by attaching the load to both strips 110 and 120). It will be understood by one of ordinary skill in the art from the description herein that by including a greater number of rolled metal strips, additional constant force options are available from system 100.

When a user of system 100 desires to attach the load to fewer than all of the available strips, the user attaches the load first to the outermost strips (relative to their overlap). Thus, a user desiring to use only a single strip attaches the load to strip 120 of system 100. This is due to the operation of spool 130, which is explained below.

As set forth above, when second strip 120 is attached to a load, it is configured to unroll. However, even if first strip 110 is not attached to the load, first strip 110 is configured to unroll when second strip 120 unrolls. This is caused in part by friction between strips 110 and 120 due to their overlapping arrangement, and by the change in shape of strip 120 while it is being unrolled. Thus, when a load is attached to only the outermost strip (e.g. strip 120), the remaining strip or strips (e.g. strip 110) will unroll as well.

However, because there is no load exerting a force on strip 110, there is nothing keeping strip 110 in the stressed, unrolled position. Accordingly, when strip 110 is unrolled and unattached to the load, strip 110 is configured to reroll around spool 130. In this way, strip 110 does not apply a constant force to the load, but instead returns to its relaxed, rolled position (around spool 130). When strip 120 is unattached from the load, strip 120 will reroll into the relaxed, fully rolled position around the first axis, bringing strip 110 along with it.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. An adjustable constant-force spring system comprising:
a first rolled metal strip, the first strip rolled around a first axis, the first strip having an inner end adjacent the first axis and an outer end configured for selective attachment to a load;
a second rolled metal strip, the second strip rolled around the first axis such that the second strip overlaps the first strip, the second strip having an inner end adjacent the first axis and an outer end configured for selective attachment to the load; and
a spool located on a second axis parallel to and spaced from the first axis, the spool sized to enable the first strip to reroll around the spool.

2. The system of claim 1, wherein the second strip is configured to unroll when its outer end is attached to the load.

3. The system of claim 2, wherein the first strip is configured to unroll when the second strip unrolls.

4. The system of claim 3, wherein the first strip is configured to reroll around the spool when the first strip is unrolled and is unattached to the load.

5. The system of claim 1, wherein each of the first and second strips provides a constant force substantially independent of an unrolled length of the first and second strips.

6. The system of claim 5, wherein the first strip and the second strip provide the same constant forces.

7. The system of claim 5, wherein the first strip and the second strip provide different constant forces.

8. The system of claim 1, wherein the first and second strips each have an attachment point formed at the respective outer ends thereof.

9. The system of claim 8, wherein each attachment point comprises a hole formed in the respective strip.

10. The system of claim 1, further comprising a housing, the first and second strips positioned within the housing such that the outer ends of the first and second strips protrude from the housing toward the spool.

11. The system of claim 10, wherein the spool is fixedly coupled to the housing.

12. An adjustable constant-force spring system comprising:
a circular drum positioned around a first axis;
a plurality of rolled metal strips positioned around the drum, the plurality of strips rolled around the drum in overlapping fashion, each strip having an inner end adjacent the drum and an outer end configured for selective attachment to the load; and
a spool fixedly coupled to the drum, the spool located on a second axis parallel to and spaced from the first axis, wherein
an outermost strip of the plurality of strips is configured to unroll when its outer end is attached to the load,
an inner strip of the plurality of strips is configured to unroll when the outermost strip unrolls, and
the inner strip is configured to reroll around the spool when the inner strip is unrolled and is unattached to the load.
